(19) United States
(12) Patent Application Publication
(10) Pub. No.: US 2010/0327166 A1
(43) Pub. Date: Dec. 30, 2010

(54) INFRARED SENSOR

(75) Inventor: Koh Takahashi, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: UNIVERSAL ENTERTAINMENT CORPORATION, Tokyo (JP)

(21) Appl. No.: 12/865,611

(22) PCT Filed: Jan. 22, 2009
(86) PCT No.: PCT/JP2009/050967

§ 371 Date: Jul. 30, 2010

(30) Foreign Application Priority Data
Feb. 4, 2008 (JP) 2008-024005

(51) Int. Cl. G01J 5/12

(52) U.S. Cl. 250/338.1

(57) ABSTRACT

An infrared sensor includes a substrate including an insulating layer formed thereon, a thermoelectric conversion element mounted on the substrate through the insulating layer, and an infrared absorbing layer mounted on the thermoelectric conversion element. The thermoelectric conversion element includes at least one single element having a heating surface defined as one side face and a cooling surface defined as the opposite face of the heating surface, for generating an electric power from the temperature difference made between the heating surface and the cooling surface. The single element includes a sintered cell including a composite metallic oxide, a pair of electrodes formed on the heating surface and the cooling surface of the sintered cell, and lead wires connecting the electrode on the heating surface and the electrode on the cooling surface electrically in series.

### TECHNICAL FIELD

The present invention relates to an infrared sensor, and in particular relates to an infrared sensor having high thermoelectric conversion efficiency and being simple in construction.

### BACKGROUND ART

Infrared sensors are generally classified into heat-type infrared sensors and quantum-type infrared sensors according to operating principles. Among these, the heat-type infrared sensor detects infrared rays by converting a temperature-rise rate of an infrared sensitive portion by way of heat energy converted from incident infrared rays into an electric signal. As a means for converting the temperature rise of the infrared sensitive portion into an electric signal, for example, a thermocouple or thermoelectric conversion element is employed.

For example, a product employing a thermocouple composed of metal such as chromel-alumel can be exemplified as a heat-type infrared sensor. However, since the Seebeck coefficient of a metal such as chromel-alumel is merely on the order of tens of μV/K, a thermopile (thermo-pile) type infrared sensor in which many thermocouples are connected in series in order to obtain sufficient output electric power is put into practical use.

As the thermopile used in a thermopile-type infrared sensor, for example, thermoelectric conversion element examples formed by connecting thermoelectric conversion elements composed of alloys of p-type and n-type Bi, Sb, Se and Te have been proposed (e.g., refer to Japanese Unexamined Patent Application, Publication No. H01-179376).

However, although semiconductors of a Bi—Te system or Si—Ge system used in heat-type infrared sensors employing thermoelectric conversion elements composed of semiconductors of a Bi—Te system or Si—Ge system, such as of Japanese Unexamined Patent Application, Publication No. H01-179376, show excellent thermoelectric characteristics in the temperature region around room temperature and the middle temperature region of 300 to 500° C., they have low heat resistance in the high temperature region. In addition, semiconductors of a Bi—Te system or Si—Ge system raise production cost and are a large environmental burden since they contain Te, Ge, etc., which are high priced and toxic metallic elements.

Therefore, in order to avoid using such high priced and toxic metallic elements, and to realize a cost reduction in infrared sensors, an infrared sensor has been proposed in which a first element composed mainly of zinc oxide and a second element composed mainly of platinum are connected together on substrates (e.g., refer to Japanese Unexamined Patent Application, Publication No. 2004-037198).

### DISCLOSURE OF THE INVENTION

### Problems to be Solved by the Invention

However, in the infrared sensor of Japanese Unexamined Patent Application, Publication No. 2004-037198, it has been necessary to make a p-n junction between an element composed of a zinc oxide thin film (corresponding to an n-type semiconductor) and an element composed of a platinum thin film (corresponding to a p-type semiconductor). When this is done, there has been a problem in that the semiconductor characteristics are irregular due to variability in the size and shape of the elements making the p-n junction, whereby the thermoelectric conversion efficiency of the infrared sensors declines.

The present invention was made taking into account the above such problems, and an object thereof is to provide an infrared sensor that suppresses a decline in thermoelectric conversion efficiency caused by variation in semiconductor characteristics by way of curbing variation in semiconductor characteristics for each element, while being simple in construction.

### Means for Solving the Problems

The present inventors have diligently researched to solve the above problems. As a result thereof, it has been found that an infrared sensor can be provided that can suppress a decline in thermoelectric conversion efficiency caused by variation in semiconductor characteristics by way of curbing variation in the semiconductor characteristics for each element, while being simple in construction, by way of using a single element provided with a pair of electrodes at a heating surface and cooling surface of a sintered body cell constituted by a complex metal oxide, and including a conductive member that electrically connects these electrodes in series, thereby arriving at completing the present invention. More specifically, the present invention provides the following configuration.

According to a first aspect of the present invention, in an infrared sensor having a substrate on which an insulating layer is formed, a thermoelectric conversion element provided on the substrate through the insulating layer, and an infrared absorbing layer provided on the thermoelectric conversion element, the thermoelectric conversion element contains at least one single element that includes a heating surface defined as a face on a first side and a cooling surface defined as a face of an opposite side to the heating surface, and that generates electricity by way of a temperature differential occurring between the heating surface and the cooling surface, in which the single element includes a sintered body cell containing a complex metal oxide, a pair of electrodes formed on the heating surface and the cooling surface of the sintered body cell, and a conductive member that electrically connects in series an electrode on a side of the heating surface and an electrode on a side of the cooling surface.

According to the first aspect of the invention, irregularity in the semiconductor characteristics of single elements having occurred due to a p-n junction forming between different like elements can be suppressed by way of providing the pair of electrodes on the heating surface and cooling surface of the sintered body cell constituted by a complex metal oxide, and forming a single element by connecting the conductive member thereto. Consequently, it is possible to provide an infrared sensor that can suppress a decline in thermoelectric conversion efficiency caused by irregularity in semiconductor characteristics, and that has high thermoelectric conversion efficiency compared to conventionally.

Furthermore, an infrared sensor that is simple in construction can be provided by forming thermoelectric conversion elements or thermopiles as a single element.

According to a second aspect of the present invention, in the infrared sensor as described in the first aspect, the thermoelectric conversion element contains a plurality of the single element, and the electrode on the side of the heating surface and the electrode on the side of the cooling surface of respective sintered body cells adjacent to each other in the single element are electrically connected in series by the conductive member.

According to the second aspect of the invention, the electromotive force of the thermoelectric conversion element can be increased by using thermoelectric conversion elements in which a plurality of single elements are electrically connected in series by way of conductive members.

According to a third aspect of the present invention, in the infrared sensor as described in the first or second aspect, the single elements contain the same material.

According to the third aspect of the invention, the semiconductor characteristic can be made uniform for each single element of the thermoelectric conversion element by forming the thermoelectric conversion elements of the same material, and preferably to be the same size and same shape. As a result, it is possible to suppress irregularity in the semiconductor characteristics of the single element, and the thermoelectric conversion efficiency of the infrared sensor can be further improved.

According to a fourth aspect of the present invention, in the infrared sensor as described in any one of the first to third aspects, the complex metal oxide includes an alkali earth element and manganese.

According to a fifth aspect of the present invention, in the infrared sensor as described in the fourth aspect, the complex metal oxide is represented by the following general formula (I),

Ca₍₁ₓ₎MₓMnO₃ (I)

in which M is at least one element selected from the group consisting of yttrium and a lanthanoid, and x is in the range of 0 to 0.05.

According to the fourth and fifth aspects of the invention, the heat resistance of the infrared sensor at high temperatures can be further raised by forming a complex metal oxide from oxides in which an alkali earth element, rare earth element, and manganese are made constituent elements, and preferably from Ca₍₁₋ₓ₎MₓMnO₃ (in which, M is at least one element selected from among yttrium and a lanthanoid, and x is in the range of 0 to 0.05).

According to a sixth aspect of the present invention, in the infrared sensor as described in the fifth aspect, the x in the general formula (I) is 0.

According to the sixth aspect of the invention, the Seebeck coefficient can be further raised up to approximated 400 μV/K by adopting a sintered body cell composed of CaMnO₃, resulting in it being possible to increase the electromotive force of the thermoelectric conversion element. As a result, it is possible to provide an infrared sensor that can decrease the number of single elements used in the thermoelectric conversion element, while being lower priced and simple in construction.

According to a seventh aspect of the present invention, in the infrared sensor as described in any one of the first to sixth aspects, the pair of electrodes is formed by applying a conductive paste on the heating surface and the cooling surface of the sintered body cell, and sintering.

According to the seventh aspect of the invention, it is possible to form a thin electrode since the electrode is formed by directly applying a conductive paste onto the heating surface and the cooling surface of the sintered body cell. In addition, it is possible to provide an infrared sensor that can improve thermal conductivity and electrical conductivity and has high thermoelectric conversion efficiency since using a binder as done conventionally is not required.

### EFFECTS OF THE INVENTION

According to the present invention, it is possible to provide an infrared sensor that suppresses a decline in thermoelectric conversion efficiency by curbing variation in semiconductor characteristics for each element, while being simple in construction.

### BRIEF DESCRIPTION OF THE DRAWINGS

FIG. 1 is a perspective view showing an infrared sensor S according a first embodiment;

FIG. 2 is a cross-sectional view when sectioned along a plane A-A′ of FIG. 1; and

FIG. 3 is a perspective view showing an infrared sensor S′ according to a second embodiment.

### EXPLANATION OF REFERENCE NUMERALS

S, S′ infrared sensor
10, 50 substrate
11, 51 insulating layer
20, 60 thermoelectric conversion element
21, 61 sintered body cell
22, 23, 62, 63 electrode
24 lead wire
25, 65 single element
12, 13, 52, 53 connector
30, 70 infrared absorption layer

### PREFERRED MODE FOR CARRYING OUT THE INVENTION

Embodiments of the present invention will be explained below with reference to the drawings. It should be noted that, in the explanation of the second embodiment, suitable explanations may be omitted for passages that would be redundant with the explanation of the first embodiment; however, the aim of the present invention is not to be limited thereby.

### First Embodiment

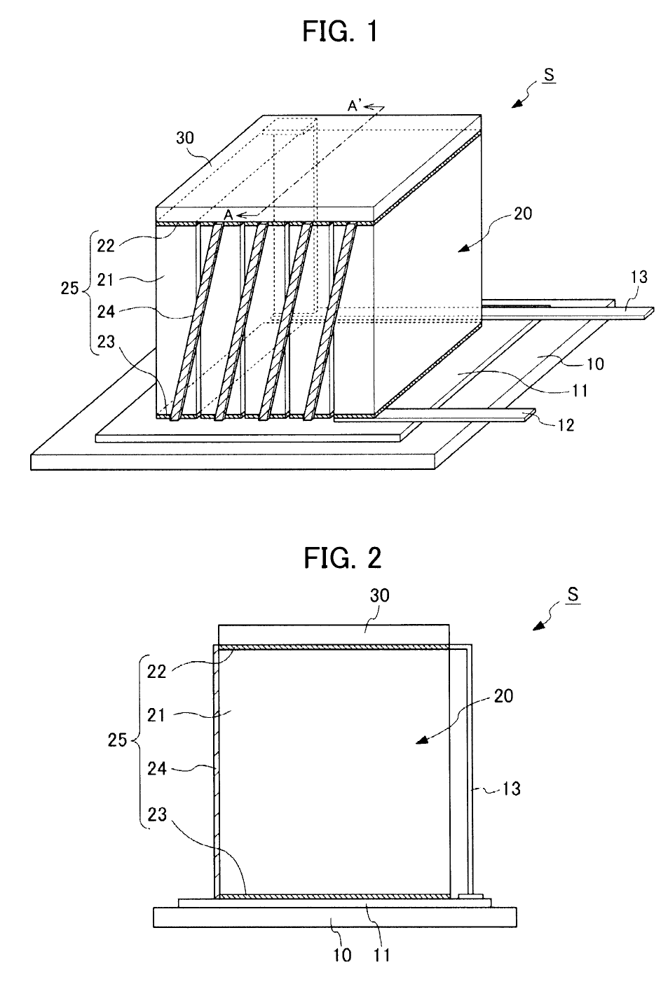

An infrared sensor S according to the first embodiment of the present invention is shown in FIGS. 1 and 2. As shown in FIGS. 1 and 2, the infrared sensor S according to the first embodiment includes a substrate 10 on which an insulating layer 11 is formed, a thermoelectric conversion element 20 provided on the substrate 10 through the insulating layer 11, and an infrared absorbing layer 30 provided on the thermoelectric conversion element 20. The infrared sensor S is characterized by including a plurality, specifically 5, single elements as the thermoelectric conversion element 20.

### Insulating Layer 11, Substrate 10

The substrate 10 is not particularly limited, and a convention well-known substrate may be used. For example, a flat substrate composed of silicon and the like may be used. In addition, as long as the insulating layer 11 is a material having insulating properties, it is not particularly limited. For example, in addition to an insulating layer having a protective feature composed of silicon nitride and the like, an insulating layer composed of nitrides such as AlN, TiN, TaN and BN, carbides such as SiC, fluorides such as MgF, and the like may be used.

### Thermoelectric Conversion Element 20

The thermoelectric conversion element 20 is provided on the substrate 10 through the insulating layer 11. The thermoelectric conversion element 20 has a heating surface defined as a face of a first side and a cooling surface defined as a face of an opposite side to the heating surface, and includes five single elements 25, which produce electricity by way of the temperature differential occurring between the heating surface and the cooling surface. These five single elements 25 respectively have a sintered body cell 21, a pair of electrodes 22 and 23, a lead wire 24 as a conductive member, and connectors 12 and 13. By using such a thermoelectric conversion element 20 including five of the single elements 25, it is possible to suppress a decline in thermoelectric conversion efficiency, which causes inconsistency in semiconductor characteristics occurring due to a p-n junction of different like elements.

### Sintered Body Cell 21

A sintered body composed of a complex metal oxide may be used as the sintered body cell 21. The sintered body composed of a complex metal oxide has a high Seebeck coefficient of at least about 100 μV/K, contrary to the Seebeck coefficient of metals such as chromel-alumel used as thermocouples in conventional thermopiles, which is on the order of tens of μV/K.

As a result, it is not necessary for the number of p-n pairs to be on the order of 100 as in a conventional thermopile, and a small number on the order of five for the number of single elements 25 will suffice, as in the present embodiment. Therefore, the structure of the infrared sensor S can be simplified, and can be made compact.

In addition, by using a sintered body composed of a complex metal oxide as the sintered body cell 21, it is also possible to improve heat resistance and mechanical strength. Furthermore, a cost reduction is achieved because complex metal oxides are cheap materials.

The shape of the sintered body cell 21 is not particularly limited, and is suitably selected according to the shape of the infrared sensor S and the like. Preferably, it is rectangular solid or a cube. The size of the sintered body cell 21 is also not particularly limited and, for example, the surface area of the heating surface and the cooling surface is preferably 5 to 20 mm×1 to 5 mm, with a height of 5 to 20 mm.

The five single elements 25 are preferably configured from the same material. It is possible to control variation in the semiconductor characteristics of each element and to more effectively suppress a decline in thermoelectric conversion efficiency of the infrared sensor S by forming the thermoelectric conversion elements 20 of the same material, and preferably to be the same size and same shape.

In addition, simplification of the structure is possible, and production cost can be reduced.

As the complex metal oxide constituting the sintered body cell 21, in view of being able to further raise the heat resistance of the infrared sensor S, a complex metal oxide containing an alkali earth element and manganese is preferred, and using a complex metal oxide represented by the following general formula (I) among these is more preferred.

Ca₍₁₋ₓ₎MₓMnO₃ (I)

In the formula (I), M is at least one element selected from among yttrium and lanthanoids, and x is in the range of 0 to 0.05.

An example of a method for producing a sintered body cell 21 composed of a complex metal oxide represented by the above general formula (I) will be explained. First, CaCO₃, MnCO₃ and Y₂O₃ are added along with purified water into a mixing pot into which pulverizing balls have been placed, the mixing pot is mounted to an oscillating ball mill and vibrated for 1 to 5 hours, thereby mixing the contents of the mixing pot. The mixture thus obtained is filtered, dried, and then the dried mixture is preliminarily calcined in an electric furnace for 2 to 10 hours at 900 to 1100° C. The preliminarily calcined body thus obtained by preliminarily calcining is pulverized with an oscillating mill, and the ground product is filtered, and dried. A binder is added to the ground product after drying, and then granulated by grading after drying. Thereafter, the granules thus obtained are molded in a press, and the compact thus obtained undergoes main calcination in an electric furnace for 2 to 10 hours at 1100 to 1300° C. The sintered body cell 21 of a CaMnO₃ system represented by the above general formula (I) is thereby obtained.

Herein, by sandwiching the sintered body cell 21 with two copper plates, and providing a temperature differential of 5° C. over the top and bottom copper plates by using a hot plate to heat the bottom copper plate, the Seebeck coefficient α of the sintered body cell 21 obtained by the above-mentioned production method can be measured from the voltage generated over the top and bottom copper plates. In addition, the resistivity ρ can be measured by the four-terminal method using a digital voltmeter.

For example, when measuring the Seebeck coefficient of the sintered body cell 21 of a CaMnO₃ system represented by the above general formula (I), a high value of at least 100 μV/K is obtained.

In the composition represented by the above general formula (I), so long as x is within the range of 0 to 0.05, it is preferable for obtaining high values for the Seebeck coefficient α and the resistivity ρ.

Above all, when x is 0, i.e. if it is the sintered body cell 21 composed of CaMnO₃ not containing impurities of yttrium or lanthanoids, it is particularly preferable because the Seebeck coefficient is further raised to approximately 400 μV/K. The number of single elements 25 constituting the thermoelectric conversion element 20 can be further reduced and the structure of the infrared sensor S can be further simplified by using the sintered body cell 21 having an extraordinarily high Seebeck coefficient of approximately 400 μV/K. It should be noted that, when measuring the resistivity ρ of the sintered body cell 21 composed of CaMnO₃, it is about 0.05 to 0.20 Ω·cm. Therefore, it is possible for the infrared sensor S to obtain the electrical output necessary.

### Electrodes 22, 23

The pair of electrodes 22 and 23 is each formed at a heating surface, which is defined as a face of a first side of the sintered body cell 21, and a cooling surface, which is defined as a face of an opposite side. The pair of electrodes 22 and 23 is not particularly limited, and conventionally known electrodes can be used. This is formed by electrically connecting copper electrodes, which are composed of a plated metal body and ceramic plates that have been metalized, to the sintered body cell 21 by solder or the like, for example, so that the temperature differential at both ends of the heating surface and cooling surface of the sintered body cell 21 is produced evenly.

Preferably, the pair of electrodes 22 and 23 is formed by a method of sintering by applying a conductive paste to the heating surface and the cooling surface of the sintered body cell 21. According to this method, the pair of electrodes 22 and 23 can be more thinly formed. In addition, since it is not necessary to use a binder as has been conventionally, declines in thermal conductivity and electrical conductivity can be avoided, and it is possible to further raise the thermoelectric conversion efficiency of the infrared sensor S. Furthermore, the structure of the thermoelectric conversion element 20 can be simplified by integrating the sintered body cell 21 with the pair of electrodes 22 and 23.

### Conductive Member

The lead wire 24 as a conductive member electrically connects in series the electrode 22 on a heating surface side and the electrode 23 on a cooling surface side of sintered body cells 21, which are adjacent to each other. The electromotive force of the thermoelectric conversion element 20 can be increased, thereby obtaining the electrical output necessary as the infrared sensor S by using a thermoelectric conversion element 20 in which five of the single elements 25 are electrically connected in series by lead wires 24.

The lead wires 24 are not particularly limited, and conventional known lead wires may be used. For example, lead wires composed of good conductive metals such as gold, silver, copper, and aluminum may be used.

Since the heat conductivity of these metals is also high, in order to avoid conduction of heat, it is preferred that it is made difficult for heat to transfer by making the cross-sectional area of the lead wire 24 to be small. More specifically, the ratio of the area of the electrodes 22 and 23 to the cross-sectional area of the lead wire 24 is preferably in the range of 50:1 to 500:1. If the cross-sectional area of the lead wire 24 is too large and outside of the above range, heat is conducted and the necessary temperature differential is not obtained, and if the cross-sectional area of the lead wire 24 is too small and outside of the above range, electric current will not to be able to flow therethrough, and mechanical strength will also be inferior.

A connector 12 and a connector 13 as conductive members electrically connect both ends of single elements, among the five single elements 25 connected in series, with an external electrode, which is not illustrated. The electric energy generated by way of the temperature differential between the heating surface and cooling surface of each of the single elements 25 can be conducted to external electrodes using the connectors 12 and 13. A material that is not easily oxidized in a high temperature oxidizing atmosphere may be used as the material of the connectors 12 and 13, and silver, brass, SUS and the like may be preferably used.

### Infrared Absorbing Layer 30

The infrared absorbing layer 30 is provided on the electrode 22 of the heating surface side of the five single elements 25 constituting the thermoelectric conversion element 20. It is possible to efficiently absorb infrared rays incident on the infrared sensor S to raise the temperature by providing the infrared absorbing layer 30.

The materials constituting the infrared absorbing layer 30 are not particularly limited, and conventional known infrared absorbing materials may be used. For example, the infrared absorbing layer 30 can be formed using NiCr. In the case of forming the infrared absorbing layer 30 with a material having electrical conductivity such as NiCr, the infrared absorbing layer 30 is preferably formed on individual electrodes 22 on the heating surface side through an insulating layer. In addition, in the case of using an infrared absorbing material composed of an organic material having insulating properties as in the present embodiment, it is possible to form the infrared absorbing layer 30 directly on the electrode 22. A mask forming film can be used as a method for forming a film of the infrared absorbing layer 30.

According to the infrared sensor S of the first embodiment assuming the above such constitution, it is possible to suppress a decline in thermoelectric conversion efficiency by curbing variation in semiconductor characteristics for each element, and make an infrared sensor having a simple structure, because the thermoelectric conversion element 20 configured by five of the single elements 25 is used.

### Second Embodiment

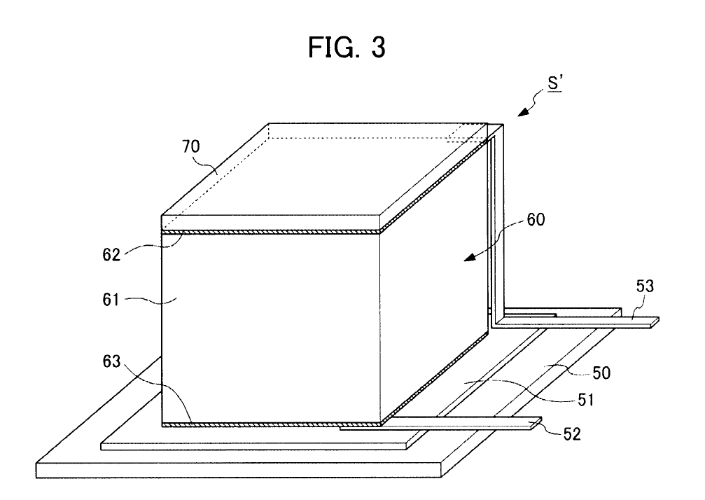

An infrared sensor S′ according to a second embodiment of the present invention is shown in FIG. 3. As shown in FIG. 3, the infrared sensor S′ according to the present embodiment is characterized by including a thermoelectric conversion element 60 constituted from one single element 65. In the present embodiment, the lead wire 24 such as of the first embodiment is not required, and connectors 52 and 53 are included as conductive members, since the thermoelectric conversion element 60 is constituted from one single element 65. In addition, the configurations other than that of the thermoelectric conversion element 60 are similar to the first embodiment.

### Thermoelectric Conversion Element 60

The thermoelectric conversion element 60 used in the infrared sensor S′ of the present embodiment is constituted from one single element 65. As a result, it is possible to suppress a decline in thermoelectric conversion efficiency caused by variation of the semiconductor characteristics to occur due to a p-n junction forming between different like elements, while a more simplified structure can be made. It should be noted that, for a sintered body cell 61 and a pair of electrodes 62 and 63 constituting the thermoelectric conversion element 60, similar materials as in the infrared sensor S according to the first embodiment may be used.

The sintered body cell 61 constituting the single element 65 is composed of a composition represented by the above general formula (I) when x is 0, i.e. CaMnO₃ that does not contain impurities of yttrium and lanthanoids. So long as it is such a sintered body cell 61, it is possible to form the infrared sensor S′ with the thermoelectric conversion element 60 composed of one single element 65 as in the present embodiment, since the Seebeck coefficient is further raised to approximately 400 μV/K.

According to the infrared sensor S′ of the second embodiment assuming the above such constitution, it is possible to effectively suppress a decline in thermoelectric conversion efficiency by further curbing variation in semiconductor characteristics for each element, and make an infrared sensor having an even simpler structure, because the thermoelectric conversion element 60 configured by merely one single element 65 is used.

It should be noted that the present invention is not to be limited to the embodiments described above, and various modification can be made thereto within a scope not deviating from the object thereof. For example, the shape and arrangement of the connectors are also not limited to the embodiments described above, and may be a shape extending below the substrate.

1. An infrared sensor including a substrate on which an insulating layer is formed, a thermoelectric conversion element provided on the substrate through the insulating layer, and an infrared absorbing layer provided on the thermoelectric conversion element,
the thermoelectric conversion element comprising at least one single element that includes a heating surface defined as a face on a first side and a cooling surface defined as a face of an opposite side to the heating surface, and that generates electricity by way of a temperature differential occurring between the heating surface and the cooling surface,
wherein the single element includes a sintered body cell containing a complex metal oxide, a pair of electrodes formed on the heating surface and the cooling surface of the sintered body cell, and a conductive member that electrically connects in series an electrode on a side of the heating surface and an electrode on a side of the cooling surface.

2. The infrared sensor according to claim 1,
wherein the thermoelectric conversion element comprises a plurality of the single element, and
wherein the electrode on the side of the heating surface and the electrode on the side of the cooling surface of respective sintered body cells adjacent to each other in the single element are electrically connected in series by the conductive member.

3. The infrared sensor according to claim 2, wherein the single elements contain the same material.

4. The infrared sensor according to claim 3, wherein the complex metal oxide includes an alkali earth element and manganese.

5. The infrared sensor according to claim 4, wherein the complex metal oxide is represented by the following general formula (I),
Ca₍₁ₓ₎MₓMnO₃ (I)
wherein M is at least one element selected from the group consisting of yttrium and a lanthanoid, and x is in the range of 0 to 0.05.

6. The infrared sensor according to claim 5, wherein the x in the general formula (I) is 0.

7. The infrared sensor according to claim 6, wherein the pair of electrodes is formed by applying a conductive paste on the heating surface and the cooling surface of the sintered body cell, and sintering.

8. The infrared sensor according to claim 1, wherein the complex metal oxide includes an alkali earth element and manganese.

9. The infrared sensor according to claim 8, wherein the complex metal oxide is represented by the following general formula (I),
Ca₍₁ₓ₎MₓMnO₃ (I)
wherein M is at least one element selected from the group consisting of yttrium and a lanthanoid, and x is in the range of 0 to 0.05.

10. The infrared sensor according to claim 9, wherein the x in the general formula (I) is 0.

11. The infrared sensor according to claim 10, wherein the pair of electrodes is formed by applying a conductive paste on the heating surface and the cooling surface of the sintered body cell, and sintering.

12. The infrared sensor according to claim 2, wherein the complex metal oxide includes an alkali earth element and manganese.

13. The infrared sensor according to claim 12, wherein the complex metal oxide is represented by the following general formula (I),
Ca₍₁ₓ₎MₓMnO₃ (I)
wherein M is at least one element selected from the group consisting of yttrium and a lanthanoid, and x is in the range of 0 to 0.05.

14. The infrared sensor according to claim 13, wherein the x in the general formula (I) is 0.

15. The infrared sensor according to claim 14, wherein the pair of electrodes is formed by applying a conductive paste on the heating surface and the cooling surface of the sintered body cell, and sintering.

16. The infrared sensor according to claim 1, wherein the single elements contain the same material.

17. The infrared sensor according to claim 16, wherein the complex metal oxide includes an alkali earth element and manganese.

18. The infrared sensor according to claim 17, wherein the complex metal oxide is represented by the following general formula (I),
Ca₍₁ₓ₎MₓMnO₃ (I)
wherein M is at least one element selected from the group consisting of yttrium and a lanthanoid, and x is in the range of 0 to 0.05.

19. The infrared sensor according to claim 18, wherein the x in the general formula (I) is 0.

20. The infrared sensor according to claim 19, wherein the pair of electrodes is formed by applying a conductive paste on the heating surface and the cooling surface of the sintered body cell, and sintering.
